(19) United States
(12) Patent Application Publication
(10) Pub. No.: US 2021/0023590 A1
(43) Pub. Date: Jan. 28, 2021

(54) PARTS CLEANING MACHINE

(71) Applicant: Heinz Rose, Yorba Linda, CA (US)

(72) Inventor: Heinz Rose, Yorba Linda, CA (US)

(21) Appl. No.: 16/523,355

(22) Filed: Jul. 26, 2019

(51) Int. Cl. B08B 3/04; B08B 13/00; B08B 3/02; B08B 1/00; B08B 1/02; B08B 1/04

(52) U.S. Cl. CPC B08B 3/041; B08B 13/00; B08B 1/04; B08B 1/002; B08B 1/02; B08B 3/022

(57) ABSTRACT

A parts cleaning machine to automatically clean just-manufactured parts (e.g., pins). The machine includes a housing and a parts guide (e.g., a tube) extending through the housing along which the parts to be cleaned are moved. A pair of brush assemblies extend through the housing at opposite sides of the parts guide. The brush assemblies have rows of bristles that are positioned to engage the parts to be cleaned that move along the parts guide. A cleaning solution manifold is located in the housing to apply cleaning solution supplied thereto from a cleaning solution reservoir to the bristles of the brush assemblies. A motor is coupled to each of the pair of the pair of brush assemblies to cause the brush assemblies to rotate so that the parts are scrubbed with the cleaning solution applied to bristles thereof. One of the pair of brush assemblies is rotated faster than the other.

### BACKGROUND OF THE INVENTION

### 1. Field of the Invention

This invention relates to a parts cleaning machine that is configured to automatically remove lubricants and similar coatings from just-manufactured parts (e.g., pins) that are fed one at a time into the machine. The parts cleaning machine includes a pair of motor driven revolving brush assemblies to which a cleaning solution is applied from an overhead cleaning solution manifold so that rows of brushes from the brush assemblies are rotated into engagement with the parts to be cleaned as the parts move through the machine.

### 2. Background Art

Mechanical parts that are manufactured are frequently covered with grease, solvents, oils and other coatings to facilitate the manufacturing process by reducing heat that is generated as a consequence of friction. Once the manufacturing process is completed, the parts must be cleaned to remove the lubricants and the other coatings with which they are covered. A common method to clean the just-manufactured parts is to load them into a tank that is typically filed with a caustic cleaning solution. A workman wearing gloves and a mask across his face will then use a brush to scrub the parts in the tank by hand. Because of the caustic nature of the cleaning solution within which his hands are submerged, the workman is often subjected to harsh chemicals and/or gases which have been known to cause illness and induce rashes on any of the workman's exposed skin. What is more, the conventional process for cleaning parts by hand is often tedious and time consuming, especially when many parts are to be handled.

Accordingly, what would be preferable is a machine that is capable of automatically cleaning a large number of just-manufactured parts without subjecting workers to the ill effects of chemicals and gases which they have been known to encounter when using a conventional process for cleaning the parts in a tank by hand.

### SUMMARY OF THE INVENTION

In general terms, a parts cleaning machine is disclosed that is configured to automatically clean a large number of just-manufactured parts (e.g., pins) that are covered with lubricants and other coatings during their manufacture. The parts cleaning machine includes a housing that sits on a reservoir that is filled with a cleaning solution. A parts feeder tube extends horizontally through the housing between a parts entry receiver at which the parts to be cleaned are fed one at a time into the machine and a parts exit cylinder at which clean parts leave the machine. The parts feeder tube includes a pair of arcuate guide rails that face one another so that the parts are pushed in a serial string through the parts cleaning machine along a feedthrough channel between the pair of guide rails of the feeder tube. A series of vertical ribs are spaced from one another along the feeder tube to prevent the parts from tilting out of their alignment with the feedthrough channel.

A pair of revolving brush assemblies extend horizontally through the housing of the parts cleaning machine adjacent opposite sides of the parts feeder tube. Each brush assembly has a set of brushes extending outwardly therefrom. A cleaning solution manifold that extends horizontally through the housing above the pair of brush assemblies has a plurality of fluid orifices formed therein. The cleaning solution manifold communicates with the cleaning solution reservoir from which a supply of cleaning solution is pumped so as to be sprayed under pressure outwardly from the fluid orifices of the manifold and downwardly on the parts and the sets of brushes of the revolving brush assemblies by which to clean the parts being pushed along the parts feeder tube of the machine.

The pair of brush assemblies are rotated by means of an air operated motor that sits on top of the housing of the parts cleaning machine. A rotation of a drive sprocket of the motor generates a driving force that is imparted by a drive chain to respective drive sprockets of the pair of brush assemblies to cause the rotation thereof. One of the brush assembly drive sprockets has a diameter that is smaller than the diameter of the other brush assembly drive sprocket so that a corresponding one of the pair of brush assemblies rotates faster than the other one of the pair. Accordingly, the sets of brushes from the rotating brush assemblies engage the parts to be cleaned that move along the feedthrough channel of the parts feeder tube and scrub the parts with the cleaning solution that is sprayed on the brushes from the overhead cleaning solution manifold.

### BRIEF DESCRIPTION OF THE DRAWINGS

FIG. 1 is a cross-section of a parts cleaning machine according to a preferred embodiment of this invention;

FIG. 2 is a perspective view of the parts cleaning machine shown in FIG. 1;

FIG. 3 is a side view of the parts cleaning machine taken with respect to the directional arrow of FIG. 2;

FIG. 4 is a perspective view of a parts feeder tube that extends horizontally through the parts cleaning machine along which parts to be cleaned are moved;

FIG. 5 is a side view of the parts feeder tube of FIG. 4;

FIG. 6 is a cross-section of the parts feeder tube taken along lines 6-6 of FIG. 4;

FIG. 7 is a perspective view of one of a pair of revolving brush assemblies that extends horizontally through the parts cleaning machine; and

FIG. 8 is a perspective view of a cleaning solution manifold that extends horizontally through the parts cleaning machine.

### DESCRIPTION OF THE PREFERRED EMBODIMENT

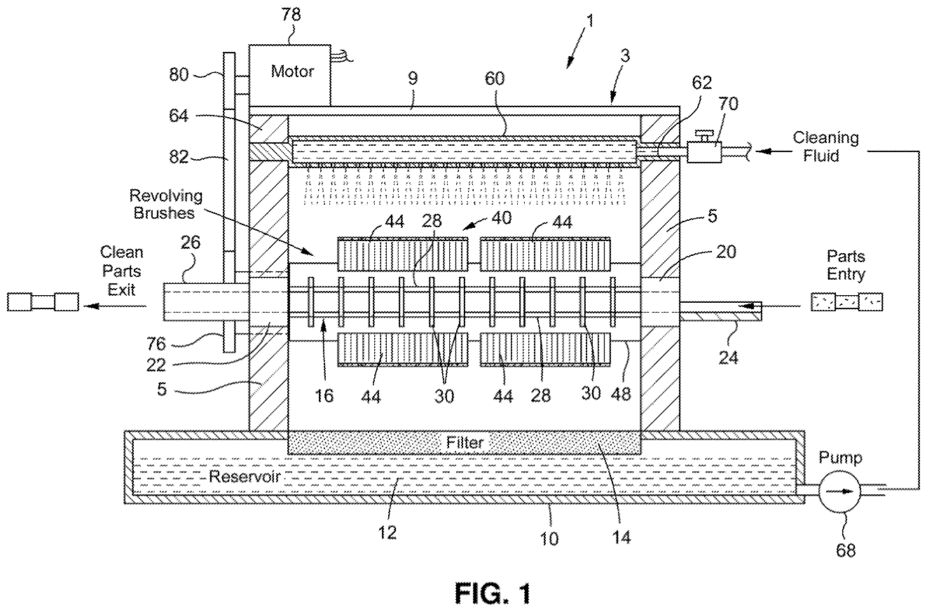

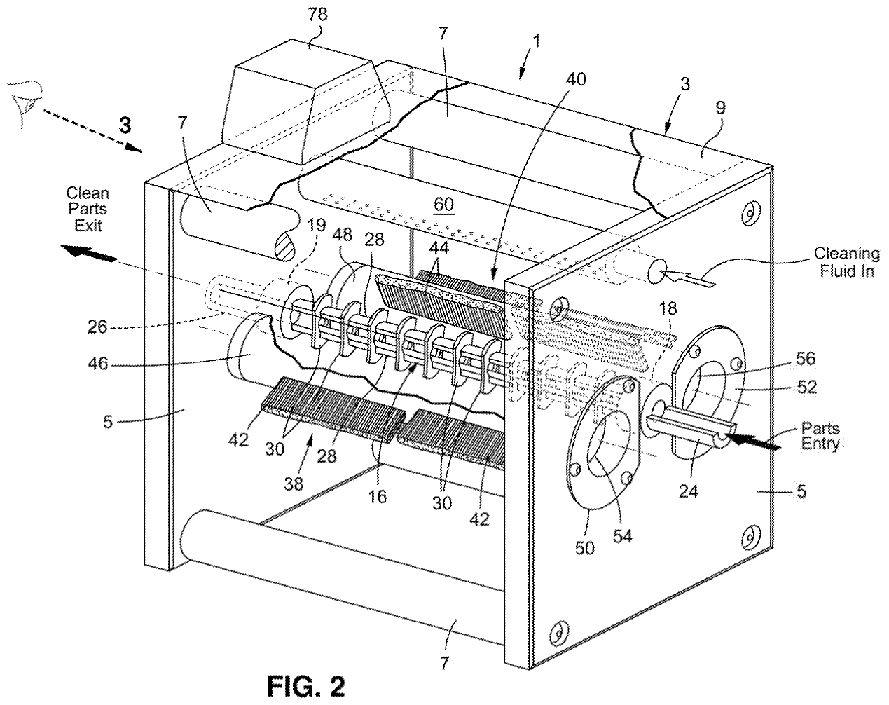

Details of a parts cleaning machine 1 according to a preferred embodiment of this invention are disclosed while referring initially to FIGS. 1 and 2 of the drawings. The parts cleaning machine 1 has particular application for automatically cleaning a large number of small mechanical parts following their manufacture. That is, the parts cleaning machine 1 herein described is especially adapted to reliably remove lubricants and other coatings with which mechanical parts are covered during their manufacturing process. By way of example only, the small mechanical parts that are ideal for cleaning by means of this invention are those commonly associated with the aircraft, automotive and medical industries to name but a few. However, it is to be understood that the particular size and type of part that is cleaned by the parts cleaning machine 1 are not to be considered a limitation as to the scope of this invention.

The parts cleaning machine 1 includes a housing 3 into which the parts to be cleaned are fed one after another. The housing 3 includes a pair of upstanding walls 5 that are held in spaced parallel alignment with one another at opposite sides of the machine 1 by pairs of upper and lower frame rods 7 that extend therebetween. The sidewalls 5 of the housing 3 of the parts cleaning machine 1 are preferably manufactured from a gray PVC. Likewise, the frame rods 7 are also preferably manufactured from PVC.

The top and the rear of the parts cleaning machine 1 are closed by (e.g., acrylic) panels (e.g., 9). The front of the parts cleaning machine 1 is open to permit access to the interior thereof if needed during the parts cleaning process. The bottom of the parts cleaning machine 1 is seated on a cleaning solution reservoir 10 that is filled with a cleaning solution 12 to be pumped into the housing 3 to clean the parts moving therethrough (best shown in FIG. 1). The reservoir 10 is shown having a filter 14 located therewithin to remove any sediment or particulate matter from the cleaning solution 12.

An elongated parts feeder tube 16 extends horizontally through the housing 3 of the parts cleaning machine 1 between the opposing sidewalls 5 of the housing 3. The parts to be cleaned are pushed by the operator of the machine through the housing 3 one after another in a serial string along the parts feeder tube 16. Cylindrical mounting collars 18 and 19 (best shown in FIG. 2) are located at the opposite ends of the feeder tube 16. The mounting collars 18 and 19 are slidably received by and removably retained within correspondingly sized mounting holes (designated 20 and 22 in FIG. 1) that are formed in the opposing sidewalls 5. The feeder tube 18 can be withdrawn (i.e., pulled outwardly) from the housing 3 and removed from the parts cleaning machine 1 via one of the collar mounting holes 20 or 22 to be cleaned or replaced with a different feeder tube should the size of the parts to be cleaned change.

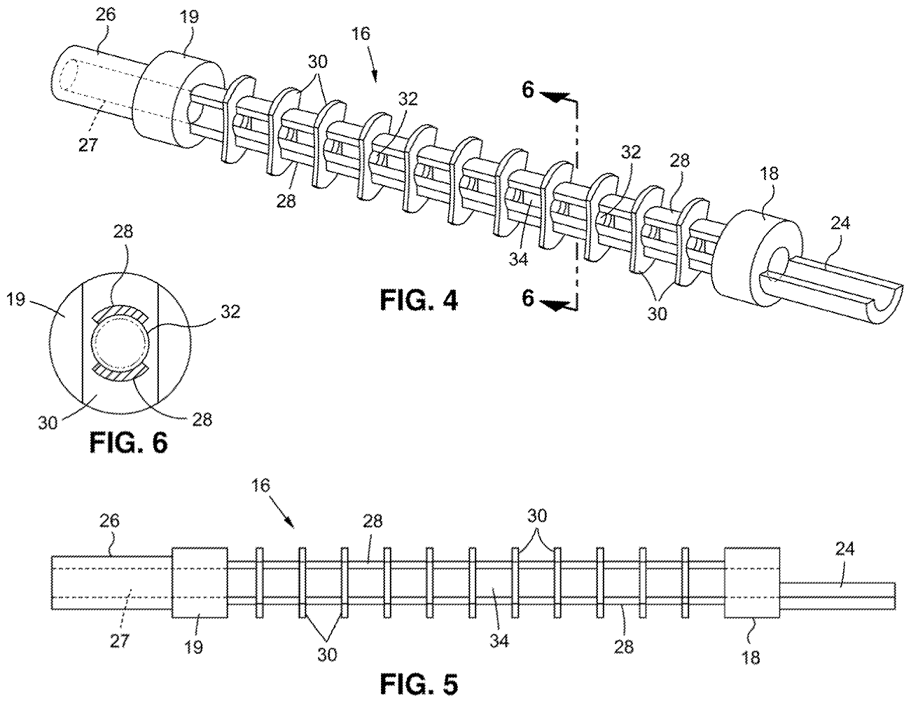

Referring concurrently now to FIGS. 1-5 of the drawings, the features of the parts feeder tube 16 that is removably received between the sidewalls 5 of the housing 3 of the parts cleaning machine 1 are explained. As is best shown in FIGS. 4 and 5, a U-shaped parts entry receiver 24 is coextensively connected to the mounting collar 18 and located at one end of the feeder tube 16. With the feeder tube 16 installed within the parts cleaning machine 1 as shown in FIG. 2, the parts entry receiver 24 projects in a first direction outwardly from one of the sidewalls 5 of the housing 3. The parts to be cleaned can be continuously fed (e.g., by hand) one at a time into the feeder tube 16 by way of the parts entry receiver 24 thereof.

A parts exit cylinder 26 having an exit channel 27 running therethrough is coextensively connected to the mounting collar 19 and located at the opposite end of the parts feeder tube 16. With the feeder tube installed within the parts cleaning machine 1, the parts exit cylinder 26 projects in an opposite direction outwardly from the opposing sidewall 5 of the housing 3. The parts that have been cleaned after being pushed through the parts cleaning machine 1 (in a manner that will soon be described) are continuously removed one at a time from the feeding tube 16 by way of the exit channel 27 of the outwardly projecting parts exit cylinder 26 to be placed or drop into a container (not shown) within which the cleaned parts can be transported.

As is also best shown in FIGS. 4 and 5, the parts feeder tube 16 which runs horizontally through the housing 3 of the parts cleaning machine 1 includes a pair of arcuate shaped guide rails 28 that extend between the cylindrical mounting collars 18 and 19 at opposing ends of the feeder tube. In the example of FIGS. 4 and 5, the pair of arcuate-shaped guide rails 28 are spaced one above the other and face one another to receive therebetween the parts to be cleaned. However, the shape of the rails 28 of the feeder tube 16 can vary from one tube to another depending upon the shape of the parts in need of being cleaned.

The parts feeder tube 16 also includes a plurality of vertical ribs 30 that are arranged in spaced parallel alignment with one another between the pair of horizontally extending rails 28 of the feeder tube. As is best shown in FIG. 6, a round center hole 32 is formed through each rib 30 such that an upper one of the pair of guide rails 28 faces downwardly and surrounds the top of the center hole 32 and a lower one of the guide rails faces upwardly and surrounds the bottom of center hole 32. Accordingly, the round center holes 32 through respective ones of the plurality of vertical ribs 30 are axially aligned with one another to establish a continuous feedthrough channel 34 that runs longitudinally along the parts feeder tube 16 by which the parts to be cleaned are pushed by the machine operator through the housing 3 between the parts entry receiver 24 and the parts exit cylinder 26 at opposite ends of feeder tube 16.

In the example illustrated in FIGS. 4-6, the parts (e.g., pins) to be cleaned that move through the axially aligned round center holes 32 will typically have a round cross section. However, in the case where different parts are to be cleaned having a different shape, the shape of the holes 32 formed through the vertical ribs 30 may be correspondingly changed.

A pair of revolving brush assemblies 38 and 40 (best shown in FIGS. 1 and 2) extend between the opposite sidewalls 5 of the housing 3 of the parts cleaning machine 1 to clean the parts that are carried by the parts feeder tube 16 through the cleaning machine 1 from the parts entry receiver 24 to the parts exit cylinder 26. Each brush assembly 38 and 40 includes a set of brushes 42 and 44 that is affixed (e.g., glued) to a cylindrical brush body 46 and 48. Each set of brushes 42 and 44 of each brush assembly 38 and 40 is divided into a plurality of rows of anti-static bristles.

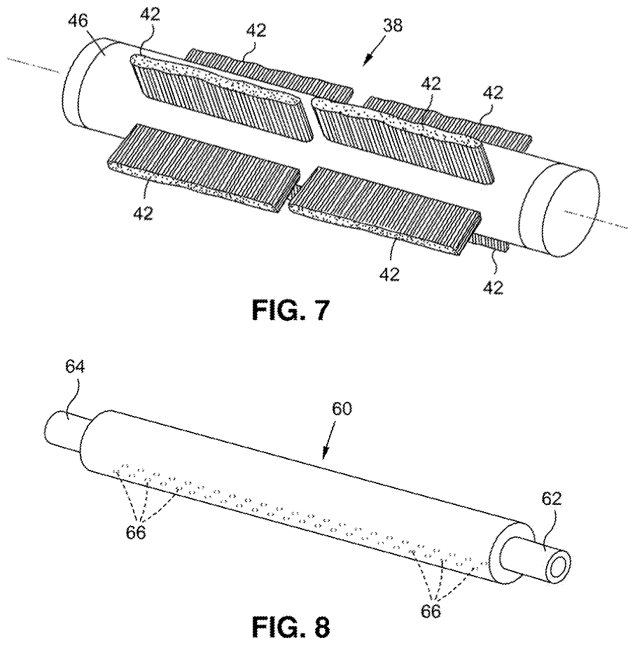

Referring in this regard to FIG. 7 of the drawings, there is shown one of the pair of brush assemblies (e.g., 38) having a cylindrical brush body 46 and, for example, four rows of brushes 42 extending radially outward from and running longitudinally along brush body 46. The rows of brushes 42 are preferably spaced equally from one another around the brush body 46 so that adjacent pairs of the rows of brushes form an angle of 90 degrees.

As is best shown in FIG. 2, the pair of revolving brush assemblies 38 and 40 are located within the housing 3 of the parts cleaning machine 1 so as to lie in parallel alignment with one another along opposite sides of the parts feeder tube 16. A pair of brush assembly end caps 50 and 52 are detachably connected to one of the pair of sidewalls 5 of housing 3. The end caps 50 and 52 surround brush assembly removal ports 54 and 56 formed through the sidewall 5 within which respective first ends of the brush assemblies 38 and 40 are received. The removal ports 54 and 56 are sized to accommodate therethrough the brush assemblies 38 and 40. That is, when the end caps 50 and 52 are detached from the sidewall 5 of housing 3, the brush assemblies 38 and 40 can be pulled outwardly and removed from the parts cleaning machine 1 by way of the exit ports 54 and 56. In this manner, a new pair of brush assemblies can be pushed inwardly and returned to the parts cleaning machine 1 via ports 54 and 56 should a previously used pair be in need of replacement due to wear or damage.

A hollow cleaning solution manifold 60 extends between the opposite sidewalls 5 of the housing 3 of the parts cleaning machine 1 so as to lie above the parts feeder tube 16 and the pair of brush assemblies 38 and 40 at opposite sides thereof. As is best shown in FIG. 8 of the drawings, the cleaning solution manifold 60 includes a fluid inlet tube 62 extending from one end thereof and a fluid outlet tube 64 extending from the opposite end. The inlet and outlet tubes 62 and 64 are received through the opposite sidewalls 5 of the housing 3 to hold the manifold 60 in place. The manifold 60 has a plurality of fluid orifices 66 formed through and running along the bottom thereof through which cleaning solution can be sprayed onto the brushes 44 to clean the parts being moved through the parts cleaning machine 1.

To this end, and as is best shown in FIG. 1, the cleaning solution manifold 60 communicates with the cleaning solution reservoir 10 on which the bottom of the housing 3 of the parts cleaning machine 1 is seated. More particularly, a pump 68 is coupled to the fluid inlet tube 62 of the manifold 60 by way of a shut-off valve 70. With the shut-off valve 70 opened, the pump 68 pumps a supply of the cleaning solution 12 under pressure from the cleaning solution reservoir 10 through the inlet tube 62 and into the cleaning solution manifold 60. Thus, when the parts to be cleaned are being advanced through the parts cleaning machine 1 along the parts feeder tube 16, the cleaning solution 12 is sprayed downwardly through the fluid orifices 66 of the manifold 60 to be applied to the rows of brushes 42 and 44 of the revolving brush assemblies 38 and 40 which engage and clean the parts.

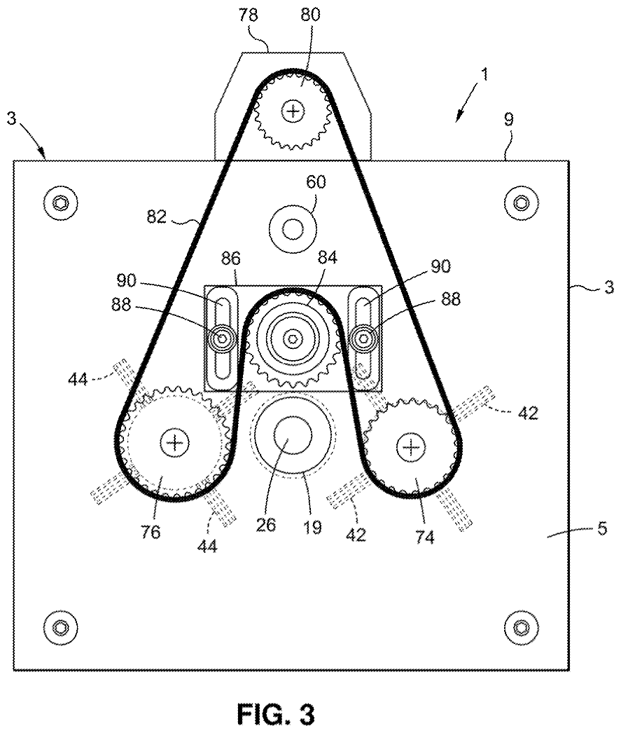

Turning to FIG. 3 of the drawings, means are shown for generating a driving force by which to cause the revolving brush assemblies 38 and 40 of FIG. 2 to rotate within the housing 3 of the parts cleaning machine 1. A first rotatable brush assembly drive sprocket 74 is located outside the cleaning machine 1 at one sidewall 5 of the housing 3. The first brush assembly drive sprocket 74 is connected through the sidewall 5 to one of the pair of brush assemblies 38 to apply a rotational force thereto. A second rotatable brush assembly brush drive sprocket 76 is also located outside the cleaning machine 1 adjacent the first drive sprocket 74. The second brush assembly drive sprocket 74 is connected through the same sidewall 5 of the housing 3 to the second of the pair of brush assemblies 40 to apply a rotational force thereto.

Each of the first and second rotatable brush assembly drive sprockets 74 and 76 is ideally a wheel having teeth extending therearound. As an important feature of this invention, and as best shown in FIG. 3, the diameter of the second rotatable brush assembly drive sprocket 76 is larger than the diameter of the first rotatable brush assembly drive sprocket 74. Thus, the smaller brush drive assembly sprocket 74 will rotate faster than the larger brush drive sprocket 76. Likewise, the brush assembly 38 to which the smaller brush assembly drive sprocket 74 is connected will rotate faster than the brush assembly 40 to which the larger brush assembly drive sprocket 76 is connected.

The sets of brushes 42 and 44 extending from the revolving brush assemblies 38 and 40 of FIG. 2 are positioned to engage and scrub the parts moving along the parts feeder tube 16 with the cleaning solution that is sprayed on the brushes 42 and 44 from the overhead cleaning solution manifold 60. By virtue of one of the brush assemblies 38 rotating faster than the other 40, the entire part is more likely to be reliably cleaned. In this same regard, it is preferable that the length of the parts (e.g., pins) moving along the feedthrough channel 34 that is created by the axially aligned center holes 32 formed in the ribs 30 of the feeder tube 16 of FIGS. 4 and 5 be equivalent to the distance between at least three successive vertical ribs 30 of the feeder tube. In this manner, the parts being cleaned will be unable to tilt sideways and move out of their alignment with the feedthrough channel 34 by which to clog the cleaning machine 1 and interrupt the parts cleaning operation.

The driving force for causing the revolving brush assemblies 38 and 40 to rotate is generated by an air operated motor 78. The motor 78 is shown in FIG. 3 mounted on the top panel 9 of the housing 3 of machine 1. A motor drive sprocket 80 is rotated by the motor 78. The motor drive sprocket 80 is coupled to the brush assembly drive sprockets 74 and 76 to impart the rotational driving force thereto generated by the motor 78.

That is, a continuous drive chain (or belt) 82 runs downwardly from the motor drive sprocket 80, under the smaller brush assembly drive sprocket 74, over a tension adjustment sprocket 84, under the larger brush assembly drive sprocket 76, and upwardly over the motor drive sprocket 80. The tension adjustment sprocket 84 is located above and between the brush assembly drive sprockets 74 and 86 to maintain the drive chain 82 in tension. The tension adjustment sprocket 84 is preferably a rotatable wheel having teeth extending therearound that is carried by a position adjustable bracket 86 lying against the sidewall 5 outside the housing 3.

The position adjustable bracket 86 is held against sidewall 5 by a pair of chain tension adjustment screws 88 that are received through a pair of tension adjustment slots 90 formed in the bracket 86. By loosening the adjustment screws 88, the position adjustable bracket 86 can slide up or down along the sidewall 5 to correspondingly move the tension adjustment sprocket 84 relative to the brush assembly drive sprockets 74 and 76. In this manner, the drive chain 82 can be maintained in constant tension over time to ensure that a rotation of the motor drive sprocket 80 by the motor 78 is imparted to the pair of revolving brush assemblies 38 and 40 of FIG. 2 as the drive chain 82 is pulled by the motor drive sprocket 80 to cause the brush assembly drive sprockets 74 and 76 to rotate and the parts to be cleaned.

1. A machine for cleaning parts, comprising:
a housing having a parts entry into which the parts to be cleaned are fed and a parts exit from which the parts are removed after being cleaned;
a parts guide extending between the parts entry and the parts exit of said housing along which the parts to be cleaned move through said housing;
at least a first brush assembly located within said housing adjacent the parts guide and having a plurality of bristles positioned so as to lie in engagement with the parts to be cleaned moving along said parts guide;
a source of cleaning fluid located within said housing adjacent said first brush assembly to apply cleaning fluid to the plurality of bristles of said brush assembly; and
a motor coupled to said first brush assembly to generate a force for causing said first brush assembly to move relative to said parts guide and for correspondingly causing the plurality of bristles of said first brush assembly to scrub the parts to be cleaned moving along said parts guide with the cleaning solution applied to said bristles from said source.

2. The machine recited in claim 1, wherein said source of cleaning fluid is a cleaning solution manifold that extends between the parts entry and the parts exit of said housing above said brush assembly, said cleaning solution manifold having fluid orifices formed therein through which the cleaning fluid is applied to the plurality of bristles of said first brush assembly.

3. The machine recited in claim 2, further comprising a cleaning solution reservoir containing a supply of cleaning solution, said cleaning solution manifold communicating with said cleaning solution reservoir to receive some of the supply of cleaning solution therefrom and apply said cleaning solution to the plurality of bristles of said first brush assembly through the fluid orifices formed in said cleaning solution manifold.

4. The machine recited in claim 3, wherein said cleaning solution manifold communicates with said cleaning solution reservoir by way of a pump so that said cleaning solution manifold receives the cleaning solution from said reservoir under pressure, and the cleaning solution is sprayed through the fluid orifices formed in said manifold onto the plurality of bristles of said first brush assembly.

5. The machine recited in claim 1, wherein said parts guide has a longitudinally extending feedthrough channel running horizontally between the parts entry and the parts exit of said housing, the parts to be cleaned moving along said feedthrough channel.

6. The machine recited in claim 5, wherein said parts guide has at least a pair of guide rails spaced from and facing one another such that said longitudinally extending feedthrough channel along which the parts to be cleaned are moved lies between said pair of guide rails.

7. The machine recited in claim 6, wherein said parts guide has first and opposite ends, the parts entry of said housing being located at the first end of said parts guide and the parts exit of said housing being located at said opposite end thereof, whereby each of said parts entry and said parts exit communicates with the longitudinally extending feedthrough channel of said parts guide.

8. The machine recited in claim 6, wherein said parts guide includes a plurality of spaced, parallel aligned ribs extending vertically between the pair of guide rails of said parts guide, each of said plurality of ribs having a hole formed therein and each of said holes being axially aligned with one another and lying in the feedthrough channel of said parts guide to accommodate the parts to be cleaned moving therethrough.

9. The machine recited in claim 8, wherein the distance between three successive ones of said parallel aligned ribs of said parts guide is equivalent to the length of each of the parts to be cleaned moving along said longitudinally extending feedthrough channel.

10. The machine recited in claim 1, wherein said first brush assembly is removable from said housing.

11. The machine recited in claim 10, wherein said housing has a brush assembly removal port formed therein, said first brush assembly responsive to a pulling force applied thereto and being sized to be removed from said housing by way of said brush assembly removal port.

12. The machine recited in claim 11, further comprising a brush assembly end cap detachably connected to said housing to surround said brush assembly removal port, said brush assembly and cap configured to be removed from said housing to enable said first brush assembly to be removed from said housing by way of said brush assembly removal port in response to the pulling force applied to said first brush assembly.

13. The machine recited in claim 1, wherein the force generated by said motor coupled to said first brush assembly causes said first brush assembly to rotate relative to said parts guide such that the plurality of bristles of said first brush assembly are correspondingly rotated to scrub the parts to be cleaned moving along said parts guide with the cleaning solution applied to said bristles from said source of cleaning solution.

14. The machine recited in claim 13, wherein said motor includes a motor drive sprocket and said first brush assembly includes a first brush assembly drive sprocket, said motor causing said motor drive sprocket to rotate, said machine further comprising a drive chain running around each of said motor drive sprocket and said first brush assembly sprocket by which said motor is coupled to said first brush assembly, the rotation of said motor drive sprocket being imparted by means of said drive chain to said first brush assembly drive sprocket for generating said force to cause said first brush assembly to rotate relative to said parts guide and thereby scrub the parts to be cleaned moving therealong.

15. The machine recited in claim 14, further comprising a second brush assembly located within said housing and having a plurality of bristles positioned in engagement with the parts to be cleaned moving along said parts guide, said first and second brush assemblies located at opposite sides of said parts guide such that the respective pluralities of bristles of said first and second brush assemblies receive cleaning fluid applied thereto from the source thereof, said motor being coupled to said second brush assembly such that the force generated by said motor also causes said second brush assembly to rotate relative to said parts guide for correspondingly causing the plurality of bristles of said second brush assembly to scrub the parts to be cleaned moving along said parts guide.

16. The machine recited in claim 15, wherein said second brush assembly includes a second brush assembly drive sprocket, said drive chain running around each of said motor drive sprocket and the first and second brush assembly drive sprockets by which said motor is coupled to said first and second brush assemblies, the rotation of said motor drive sprocket being imparted by means of said drive chain to each of said first and second brush assembly drive sprockets for generating said force to cause said first and second brush assemblies to rotate relative to said parts guide to thereby scrub the parts to be cleaning moving therealong.

17. The machine recited in claim 16, wherein one of said first and second brush assembly drive sprockets is smaller than the other such that the corresponding one of said first and second brush assemblies rotates faster than the other.

18. The machine recited in claim 16, further comprising a tension adjustment sprocket attached to said housing and located between said first and second brush assembly drive sprockets so that said drive chain runs around said tension adjustment sprocket, said tension adjustment sprocket being movable along said housing to correspondingly adjust the tension of said drive chain.

19. The machine recited in claim 18, wherein said tension adjustment sprocket is carried by a bracket connected to said housing, the position of said bracket being adjustable relative to said housing to correspondingly move said tension adjustment sprocket along said housing and thereby adjust the tension of said drive chain.

20. A machine for cleaning parts, comprising:
a housing having a parts entry into which the parts to be cleaned are fed and a parts exit from which the parts are removed after being cleaned;
a parts guide having a first end located at the parts entry of said housing and an opposite end located at the parts exit of said housing such that the parts to be cleaned move through said housing along said parts guide;
first and second rotating brush assemblies located within said housing at opposite sides of said parts guide, each of said first and second rotating brush assemblies having a plurality of bristles positioned so as to lie in engagement with the parts to be cleaned moving along said parts guide;
a cleaning solution manifold located within said housing adjacent said first and second rotating brush assemblies to apply cleaning fluid from a source thereof to the respective pluralities of bristles of said first and second rotating brush assemblies; and
a motor coupled to each of said first and second rotating brush assemblies to generate a force for causing said rotating first and second brush assemblies to rotate and for correspondingly causing the respective pluralities of bristles of said first and second rotating brush assemblies to scrub the parts to be cleaned moving along said parts guide with the cleaning solution applied to said bristles from said cleaning solution manifold, one of said first and second rotating brush assemblies rotating faster than the other.
